(19) United States
(12) Patent Application Publication
(10) Pub. No.: US 2007/0214653 A1
(43) Pub. Date: Sep. 20, 2007

(54) Thinning Tool for to a Hair Clipper

(76) Inventors: Klaus Worgull, Darmstadt (DE); Robert Kuechler, Moerfelden-Walldorf (DE)

Correspondence Address: MICHAEL J. STRIKER, 103 EAST NECK ROAD, HUNTINGTON, NY, 11743, US

(21) Appl. No.: 10/563,393

(22) PCT Filed: Aug. 2, 2004
(86) PCT No.: PCT/EP04/08626

§ 371 Date: Apr. 28, 2006

(30) Foreign Application Priority Data
Aug. 1, 2003 (DE) 103 35 228.7

(51) Int. Cl. B26B 19/22

(52) U.S. Cl. 30/195

(57) ABSTRACT

The invention relates to a thinning tool (1) for a hair clipper (2) containing lower and top shearing knives (3, 4), each of which is provided with a row of teeth (5, 6). Said top knife (4) is actuated by alternating oscillation motion in a parallel direction to said rows of teeth (5, 6), the inventive thinning tool (1) being shaped in such a way that it is arrangeable on the lower knife (3). Said thinning tool (1) comprises a row of tines (7) which forms an extension (L) of the teeth (8) of the row of teeth (5) of the lower knife (3). The row of tines (7) is provided with fine slots (11) which have a conical extension (V) on the free ends thereof for holding and guiding hairs (10). The width (B) of tine slots (11) on the side of the shearing knives (3, 4) corresponds to a hair diameter and is used for guiding the hairs (10) towards said shearing knives (3, 4). In this way, the hairs (10) are cut one by one instead of being simultaneously cut in such a way that a fine graded hair thinning is obtainable without striates by said simple means.

The invention relates to a thinning tool as generically defined by the preamble to claim 1.

A thinning tool that defines this generic type is known for instance from U.S. Pat. No. 1,903,385. In it, by means of relatively wide tine slots, many hairs at a time are cut simultaneously, which disadvantageously leads to a striplike thinning of the hair.

It is therefore the object of the invention to create a thinning tool of this same generic type with which, by simple means, a finely graduated thinning of hair without strips is attained.

This object is attained in accordance with the characteristics of the body of claim 1. Further features of the invention will become apparent from the dependent claims.

The invention is described in further detail in terms of an exemplary embodiment.

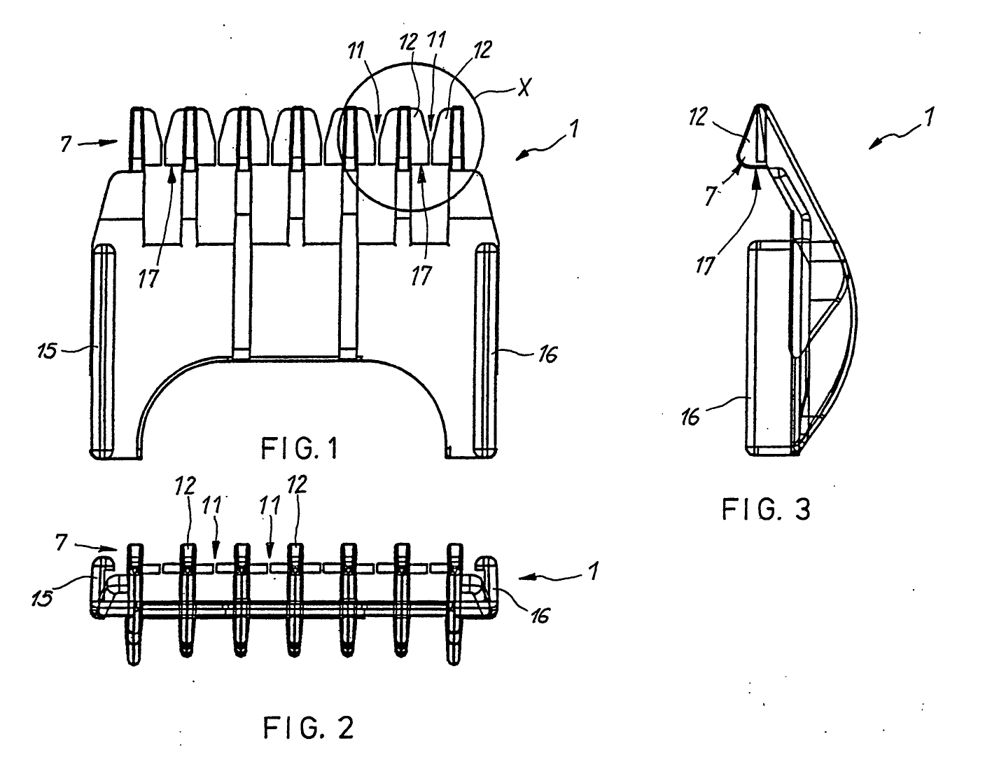

FIG. 1 shows a thinning tool in a top view;

FIG. 2 shows the thinning tool of FIG. 1 in a side view;

FIG. 3 shows the thinning tool of FIG. 1 in a view from behind;

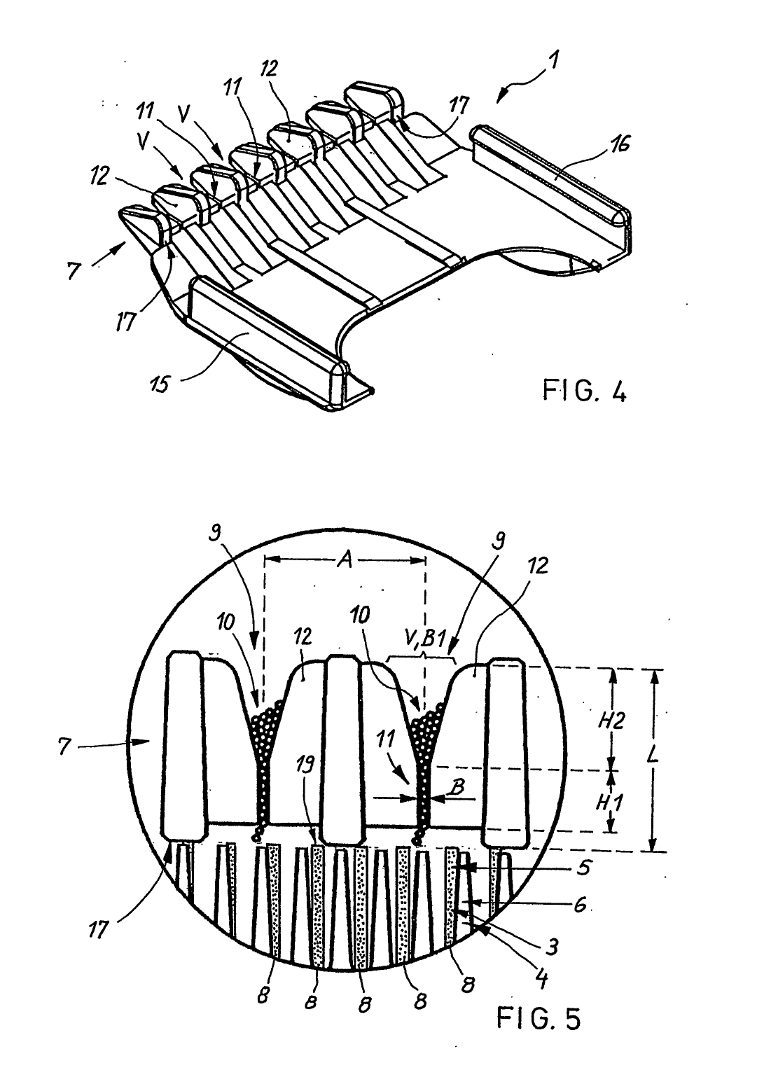

FIG. 4 shows the thinning tool of FIG. 1 in perspective;

FIG. 5 shows the thinning tool of FIG. 1 in an enlarged detail X of FIG. 1; and

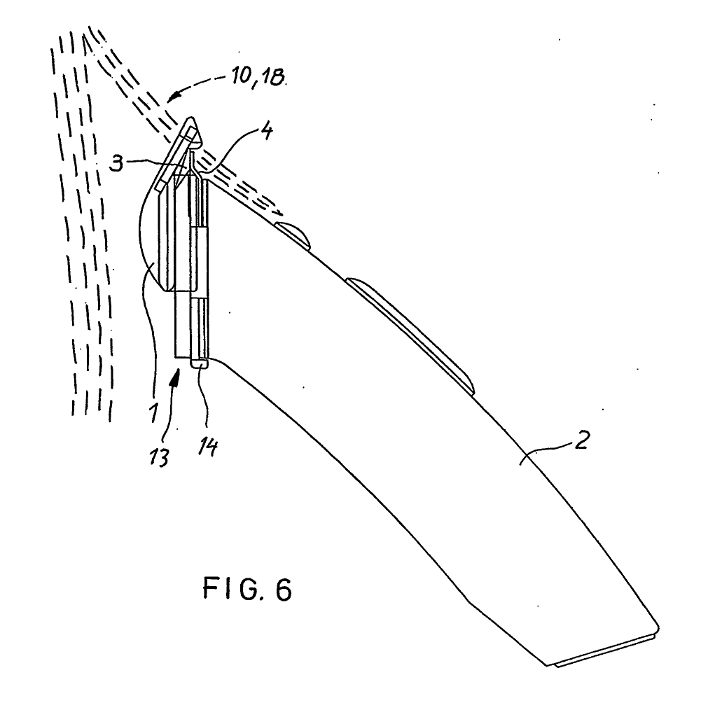

FIG. 6 shows a hair clipper with a thinning tool placed on it, in a side view.

FIGS. 1 through 4 in conjunction with the detail shown in FIG. 5 show a thinning tool 1 for an electric hair clipper 2 (FIG. 6), which has one lower shearing blade 3 and one upper shearing blade 4, each with a row of teeth 5, 6, and which is embodied as a blade head 13 that can be detached again, with an integrated hair length adjusting device 14. The upper shearing blade 4 can be swung back and forth parallel to the rows of teeth 5, 6, and the thinning tool 1 is embodied so that it can be slipped onto the lower shearing blade 3 by means of two diametrically opposed retaining rails 15, 16. The row of teeth 7 is provided on the lower end with stops 17, which abut against the free end 19 of the lower shearing blade 3, thereby fixing the thinning tool 1 to the lower shearing blade 3. The thinning tool 1 is provided with a row of tines 7, which forms an extension L of teeth 8 of the row of teeth 5 of the lower shearing blade 3. The row of tines 7 is provided with tine slots 11, which are provided on their free end with a conical enlargement V for catching and guiding hairs 10. The tine slots 11, toward the shearing blades 3, 4 have at least the width B of the diameter of a hair, for guiding the hairs 10 to the shearing blades 3, 4. As a result, instead of being cut simultaneously, the hairs 10 are cut in succession, and by these simple provisions, a finely graduated thinning of hair without strips is thus attained. The thinning tool 1 is preferably made from plastic.

FIG. 2 shows the thinning tool 1 of FIG. 1 in a side view.

FIG. 3 shows the thinning tool 1 of FIG. 1 in a view from behind.

FIG. 4, for the sake of better illustration, shows the thinning tool 1 of FIG. 1 in perspective.

FIG. 5 shows the thinning tool 1 of FIG. 1 in an enlarged detail X of FIG. 1. The tine slot 11 is provided with a width B of from 0.2 to 1.0 mm, and preferably with the width B of approximately 0.3 mm. The tine slot 11 has a height H1 of from 1 to 2 mm, and preferably a height H1 of approximately 1.5 mm. The conical enlargement V has a height H2 of approximately 3 mm. On the free end 9, the conical enlargement V has a width B1 of approximately 2 mm.

The row of tines 7 is provided with tines 12, which are located at a spacing A of from 3 to 8 mm, preferably a spacing A of approximately 4 mm.

FIG. 6 shows a hair clipper with a thinning tool 1 placed on it, in a side view, during thinning of a strand 18 of hair.

Further details of the hair clipper 2 with the blade head 13 can be found from European Patent Disclosure EP 0 856 386 B1 filed by the present Applicant.

As a further development, it is provided that the thinning tool 1 be expanded with a system of different sets of for instance three different thinning tools 1 with different thinning properties. As a result, thinning cuts that reinforce the creativity of a hair stylist for a haircut can be attained in a more targeted way.

For instance, one set of three thinning tools 1 is provided with a different width B, but identical to one another, of tine slots 11; for instance, a first thinning tool 1 is provided with a first width B of 0.2 mm, a second thinning tool 1 is provided with a second width B of 0.5 mm, and a third thinning tool 1 is provided with a third width B of 1.0 mm. Depending on which thinning tool 1 is put in place, more or fewer hairs can thus be thinned in one cutting operation.

For instance, one set of three thinning tools 1 is provided with a different width B of tine slots 11 from one another. For instance, a first thinning tool 1 is provided in alternation with a first width B of 0.2 mm and a second width B of 0.4 mm; a second, thinning tool 1 is provided in alternation with a third width B of 0.3 and a fourth width B of 0.6 mm; and a third thinning tool 1 is provided in alternation with a fifth width B of 0.4 mm and sixth width B of 0.8 mm. Depending on which thinning tool 1 is used, different thinning properties are thus attained.

For instance, one set of three thinning tools 1 is provided with a different number of tines 12, so that for instance the set is provided with a first thinning tool 1 with a tine spacing A of 3 mm, a second thinning tool 1 is provided with a tine spacing A of 5 mm, and a third thinning tool 1 is provided with a tine spacing A of 8 mm. Depending on the thinning tool 1, different thinning properties are thus created.

List of Reference Numerals

1 Thinning tool
2 Hair clipper
3 Lower shearing blade
4 Upper shearing blade
5 Lower row of teeth
6 Upper row of teeth
7 Row of tines
8 Tooth of lower shearing blade 3
9 Free end of tine slot 11
10 Hair
11 Tine slot
12 Tine
13 Blade head
14 Hair length adjusting device
15 Retaining rail
16 Retaining rail
17 Stop
18 Strand of hair
19 Free end of lower shearing blade 3
A Spacing
B Width of tine slot 11
B1 Width of enlargement V
H1 Slot height
H2 Enlargement height
L Extension
V Conical enlargement

1. A thinning tool (1) for an electric hair clipper (2), which has a lower shearing blade and an upper shearing blade (3, 4), each with a respective row of teeth (5, 6), that the upper shearing blade (4) is swingable back and forth parallel to the rows of teeth (5, 6), and the thinning tool (1) is embodied as placeable on the lower blade (3), characterized in that the thinning tool (1) is provided with a row of tines (7), which forms an extension (L) of teeth (8) of the row of teeth (5) of the lower shearing blade (3); that the row of tines (7) is provided with tine slots (11); that the tine slots (11) are provided on the free end (9) with a conical enlargement (V) for catching and guiding hairs (10); and that the tine slots (11) toward the shearing blades (3, 4) have at least a width (B) of the diameter of a hair, for carrying the hair (10) to the shearing blades (3, 4).

2. The thinning tool as recited in claim 1, characterized in that the tine slot (11) is provided with a width (B) of from 0.2 to 1.0 mm.

3. The thinning tool as recited in claim 1, characterized in that the tine slot (11) is provided with a width (B) of approximately 0.3 mm.

4. The thinning tool as recited in claim 1, characterized in that the tine slot (11) is provided with a height (H1) of from 1 to 2 mm.

5. The thinning tool as recited in claim 1, characterized in that the tine slot (11) is provided with a height (H1) of approximately 1.5 mm.

6. The thinning tool as recited in claim 1, characterized in that the conical enlargement (V) has a height (H2) of approximately 3 mm.

7. The thinning tool as recited in claim 1, characterized in that the conical enlargement (V) has a width (B1) on the free end (9) of approximately 2 mm.

8. The thinning tool as recited in claim 1, characterized in that the row of tines (7) is provided with tines (12) which are located at a spacing (A) of from 3 to 8 mm.

9. The thinning tool as recited in claim 1, characterized in that the row of tines (7) is provided with tines (12) which are located at a spacing (A) of approximately 4 mm.

10. The thinning tool as recited in claim 1, characterized by a system of at least one set of different thinning tools (1) with different thinning properties.

11. The thinning tool as recited in claim 10, that a set of thinning tools (1) is provided with a width (B) of tine slots (11) that is different but the same as each other.

12. The thinning tool as recited in claim 10, that a set of thinning tools (1) is provided with a width (B) of tine slots (11) that is different from one other.

13. The thinning tool as recited in claim 10, that a set of thinning tools (1) is provided with a different number of tines (12).
